(19) United States
(12) Patent Application Publication
(10) Pub. No.: US 2025/0156530 A1
(43) Pub. Date: May 15, 2025

(54) SYSTEMS AND METHODS FOR GENERATING AN INNOVATIVE USER INTERFACE FOR ENDPOINT DETECTION AND RESPONSE (EDR) SYSTEMS

(71) Applicant: Acronis International GmbH, Schaffhausen (CH)

(72) Inventors: Georgy PASHKOV, Sofia (BG); Serg Bell, Costa Del Sol (SG); Stanislav Protasov, Singapore (SG)

(21) Appl. No.: 18/506,423

(22) Filed: Nov. 10, 2023

(51) Int. Cl. G06F 21/54; G06F 21/55; G06F 21/56

(52) U.S. Cl. CPC G06F 21/54; G06F 21/552; G06F 21/566

(57) ABSTRACT

Disclosed herein are systems and method for generating an innovative user interface for endpoint detection and response (EDR) systems. In one aspect, a method may include detecting a plurality of actions performed on a computing device; for each respective action of the plurality of actions: identifying a source object performing the respective action and a target object on which the respective action is performed; determining whether any of the source object and the target object is a malicious object; in response to detecting at least one malicious object, generating, for display on a graphical user interface, an attack chain including a plurality of branches associated with the at least one malicious; and visually marking, on the graphical user interface, the at least one malicious object on the attack chain.

### FIELD OF TECHNOLOGY

The present disclosure relates to the field of data security, and, more specifically, to systems and methods for generating an innovative user interface for endpoint detection and response (EDR) systems.

### BACKGROUND

Information security at endpoint devices is susceptible to threats from various forms of malicious software, cyberattacks, and internal vulnerabilities. Identifying such incidents can be intricate—demanding continuous monitoring and analysis of activity on endpoints. Endpoint Detection and Response (EDR) systems gather and analyze extensive amounts of data, such as event logs, user activity, and processes. Processing and analyzing such data necessitates effective methods to detect anomalies and suspicious activities.

Upon detecting a security incident, providing users with tools for immediate response and adequate incident management is pivotal. Unfortunately, EDR systems can prove complex for end-users and administrators. It is crucial to develop a user interface that enables users to efficiently interact with the system—providing essential information and functionality. Properly visualizing collected data and information about security incidents can significantly streamline and expedite decision-making processes. Methods for efficient data visualization are thus needed for analysis and user presentation.

### SUMMARY

In one exemplary aspect, the techniques described herein relate to a method for generating an innovative user interface for endpoint detection and response (EDR) systems, the method including: detecting a plurality of actions performed on a computing device; for each respective action of the plurality of actions: identifying a source object performing the respective action and a target object on which the respective action is performed; determining whether any of the source object and the target object is a malicious object; in response to detecting at least one malicious object, generating, for display on a graphical user interface, an attack chain including a plurality of branches associated with the at least one malicious object, wherein each branch of the plurality of branches includes a first visual identifier of a respective source object, a second visual identifier of a respective target object, and a third visual identifier of a respective action; and visually marking, on the graphical user interface, the at least one malicious object on the attack chain.

In some aspects, the techniques described herein relate to a method, further including: generating, for display on the graphical user interface, an attack summary describing an origin of the at least one malicious object and target objects affected by the at least one malicious object.

In some aspects, the techniques described herein relate to a method, wherein generating the attack summary includes: identifying a branch in the attack chain; determining, from a plurality of summary templates, a summary template that corresponds to the branch based on at least one of an action, a source object, and a target object of the branch, wherein the summary template includes text describing an attack event and fields for entering identifiers of the action, the source object, and the target object of the branch.

In some aspects, the techniques described herein relate to a method, wherein the attack summary includes visual identifiers of the at least one malicious object and the target objects affected by the at least one malicious object.

In some aspects, the techniques described herein relate to a method, further including: determining a severity level associated with the at least one malicious object based on an amount of target objects affected by the at least one malicious object; and generating the severity level for display on the graphical user interface.

In some aspects, the techniques described herein relate to a method, wherein the severity level is a function of an importance of each target object and a type of action applied on each target object by the at least one malicious object.

In some aspects, the techniques described herein relate to a method, further including: receiving a selection of a visual identifier associated with the at least one malicious object; in response to receiving the selection, generating, for display on the graphical user interface, a window that includes additional information about the at least one malicious object.

In some aspects, the techniques described herein relate to a method, wherein the additional information includes a verdict on maliciousness, a reason of detection, a tactic used for malicious activity, a detection date, a security definition used to detect the at least one malicious object.

In some aspects, the techniques described herein relate to a method, further including: in response to receiving the selection, modifying visual identifiers not directly associated as source objects or target objects with the at least one malicious object such that the attack chain solely depicts visual identifiers of the at least one malicious object.

In some aspects, the techniques described herein relate to a method, further including: generating, for display on the graphical user interface, a timeline associated with the attack chain, wherein each time indicator of the timeline corresponds to a respective branch of the attack chain.

In some aspects, the techniques described herein relate to a method, further including: receiving a selection of a first time indicator on the timeline; generating, for display on the graphical user interface, a highlighting visual on a first branch corresponding to the first time indicator; and generating, for display on the graphical user interface, a time window depicting a timestamp of when a first action of the first branch was performed.

It should be noted that the methods described above may be implemented in a system comprising a hardware processor. Alternatively, the methods may be implemented using computer executable instructions of a non-transitory computer readable medium.

In some aspects, the techniques described herein relate to a system for generating an innovative user interface for endpoint detection and response (EDR) systems, including: at least one memory; and at least one hardware processor coupled with the at least one memory and configured, individually or in combination, to: detect a plurality of actions performed on a computing device; for each respective action of the plurality of actions: identify a source object performing the respective action and a target object on which the respective action is performed; determine whether any of the source object and the target object is a malicious object; in response to detecting at least one malicious object, generate, for display on a graphical user interface, an attack chain including a plurality of branches associated with the at least one malicious object, wherein each branch of the plurality of branches includes a first visual identifier of a respective source object, a second visual identifier of a respective target object, and a third visual identifier of a respective action; and visually mark, on the graphical user interface, the at least one malicious object on the attack chain.

In some aspects, the techniques described herein relate to a non-transitory computer readable medium storing thereon computer executable instructions for generating an innovative user interface for endpoint detection and response (EDR) systems, including instructions for: detecting a plurality of actions performed on a computing device; for each respective action of the plurality of actions: identifying a source object performing the respective action and a target object on which the respective action is performed; determining whether any of the source object and the target object is a malicious object; in response to detecting at least one malicious object, generating, for display on a graphical user interface, an attack chain including a plurality of branches associated with the at least one malicious object, wherein each branch of the plurality of branches includes a first visual identifier of a respective source object, a second visual identifier of a respective target object, and a third visual identifier of a respective action; and visually marking, on the graphical user interface, the at least one malicious object on the attack chain.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating an endpoint detection and response (EDR) system that generates an innovative user interface.

FIG. 2 is a diagram illustrating a user interface that includes an attack chain.

FIG. 3 is a diagram illustrating a user interface with a window describing a malicious process selected in the attack chain.

FIG. 4 illustrates a flow diagram of a method for generating an innovative user interface for an EDR system.

FIG. 5 illustrates a flow diagram of a method for generating an attack summary associated with the attack chain.

FIG. 6 illustrates a flow diagram of a method for generating a severity level.

FIG. 7 illustrates a flow diagram of a method for generating a timeline of the attack chain.

FIG. 8 presents an example of a general-purpose computer system on which aspects of the present disclosure can be implemented.

### DETAILED DESCRIPTION

Exemplary aspects are described herein in the context of a system, method, and computer program product for generating an innovative user interface for endpoint detection and response (EDR) systems. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

In the rapidly evolving digital landscape, the domain of EDR plays a pivotal role in safeguarding organizations against the continuously expanding spectrum of cyber threats. EDR systems are integral to monitoring and mitigating security incidents occurring at endpoints, thereby ensuring the integrity and confidentiality of sensitive information. However, the effectiveness of EDR solutions relies not only on robust technological frameworks, but also on the applicability and understanding of their user interfaces.

Historically, user interfaces of EDR have often been characterized by complexity, demanding significant training and experience to navigate through the multitude of data generated and analyzed by these systems. Consequently, even experienced security professionals may encounter challenges in swiftly identifying critical security incidents and orchestrating timely responses. The exponential growth of security events, coupled with the diversity of threat vectors, intensifies the demand for a user interface that strikes a balance between simplicity and multifunctionality, catering to the needs of both experienced professionals and users with varying levels of expertise.

The relevance of the proposed innovative solution lies in addressing these challenges by creating a new user interface for EDR operations. This interface aims to streamline EDR incident investigations by providing users with a powerful yet accessible toolkit. Focusing on the most crucial aspects of malware propagation and security events, the interface guides users toward well-founded operational decisions. Furthermore, the integration of innovative data visualization methods enhances the ability to recognize patterns, anomalies, and potential threats within complex datasets.

Amidst the rapidly emerging cyber threats, the influence of real-time decision-making cannot be underestimated. Organizations require solutions that enable their security teams to swiftly comprehend and respond to evolving security incidents. This is where the proposed user interface comes into play, offering a unique approach that combines ease of use and functionality. By facilitating easy navigation and extraction of valuable insights from the EDR ecosystem, this innovation promises to revolutionize the efficiency of incident response workflows, thereby fortifying organizational defenses against the ever-changing threat landscape. The amalgamation of simplicity, multifunctionality, and improved data interpretation underscores the significance of this innovation in the realm of EDR and broader cybersecurity endeavors.

The present disclosure pertains to the field of Endpoint Detection and Response (EDR) systems and describes the generation of an innovative user interface designed for the efficient resolution of day-to-day tasks associated with EDR incident investigations. Accordingly, the disclosed systems and methods create a tool that caters to users with not only ease of use, but also an extensive array of functionalities.

The delineated concept revolves around crafting a user interface that seamlessly blends intuitive control elements with multifunctional capabilities. This interface is geared towards simplifying the process of EDR incident investigation by equipping users with tools to identify the most significant events in the propagation of malicious software. One overarching goal of this concept is to furnish users with the information essential for making timely and accurate decisions in response to identified threats. The decisions may encompass features such as blocking, isolating, or responding to malicious actions.

The proposed user interface incorporates innovative data visualization methods, allowing users to discern the essence of ongoing events and focus on pivotal aspects of incidents. Furthermore, the user interface possesses the capacity to provide recommendations for operational actions based on the analysis of detected events, thus streamlining the decision-making process.

Hence, this technical solution introduces an innovative and multifunctional approach to the user interface in the realm of EDR, ensuring user-friendliness and efficacy in addressing routine tasks related to incident investigation and decision-making within the context of endpoint security.

The advantages of the exemplary user interface include: (1) simple and clear zoning of interface elements, (2) interactive attack stage summaries that guide user attention to the most critical aspects of an attack and enable faster investigation and swift operational decisions for threat mitigation, and (3) a visualization of the attack propagation chain, which facilitates rapid correlation of attack nodes and their timing, featuring a multi-tiered structure that seamlessly translates to the attack timeline.

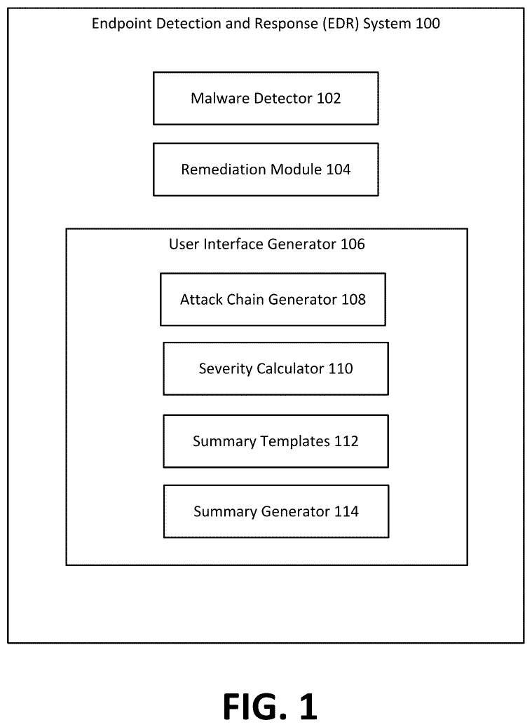

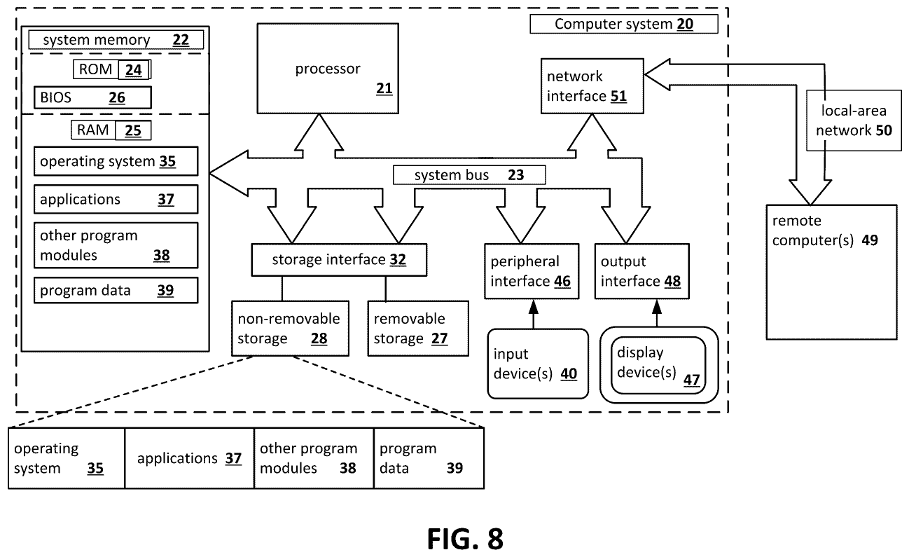

FIG. 1 is a block diagram illustrating an endpoint detection and response (EDR) system 100 that generates an innovative user interface. EDR system 100 may be installed on a computing device (e.g., computer system 20 of FIG. 8).

In an exemplary aspect, EDR system 100 includes malware detector 102, remediation module 104, and user interface generator 106. Malware detector 102 is a module that scans a plurality of objects on the computing device and identifies objects that are associated with malicious activity. An object may be some type of data such as a file, a thread, a process, etc. Remediation module 104 is a solutions module that determines the type of malicious objects that are detected by malware detector 102 and provides a plurality of remediation actions available to a user. For example, malware detector 102 may detect a malicious object and, based on the malicious object, remediation module 104 may determine that the remediation actions include: deleting the malicious object, quarantining the malicious object, performing a recovery of the computing device using a backup. Malware detector 102 and remediation module 104 may be modules of standard EDR systems 100.

Unlike conventional EDR systems, however, EDR system 100 further includes user interface generator 106, which is configured to present the information from malware detector 102 and remediation module 104 in an intuitive user-friendly manner. User interface generator 106 includes attack chain generator 108, severity calculator 110, summary templates 112, summary generator 114. Each of these are modules that are executed by user interface generator 106.

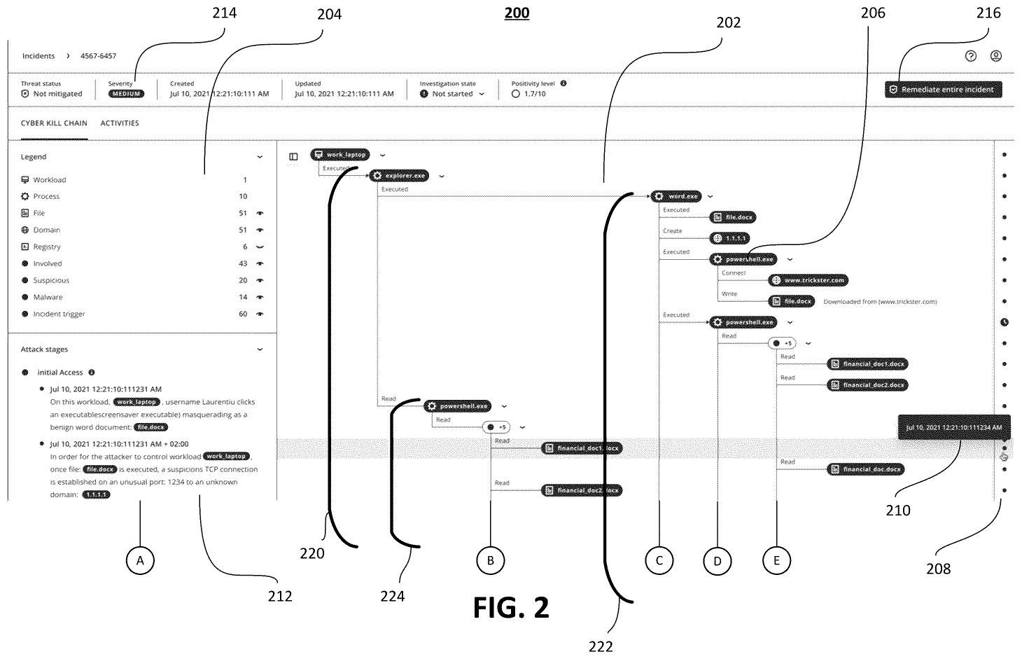

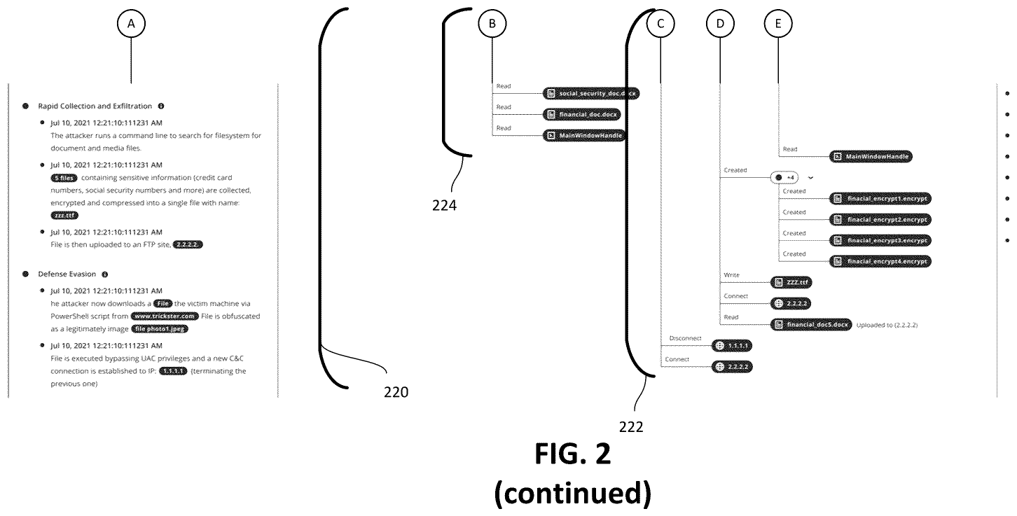

For example, attack chain generator 108 is configured to detect actions (e.g., read, write, execute, open, create, etc.) being performed on the computing device. In response to detecting an action, attack chain generator 108 identifies the source object that performed the action and a target object on which the action was performed. Attack chain generator 108 then creates a branch on an action chain in real-time on a user interface. The branch visually depicts the source object, the action, and the target object. Suppose that the target object then performs another action on a different target object. In this case, attack chain generator 108 adds a new branch to the attack chain with the target object now being the source object of the new branch. This is further explained in reference to FIG. 2.

Severity calculator 110 is a module that relatively quantifies the outreach of a malicious object. Outreach refers to the amount of objects that the malicious object has modified, created, read from, or deleted. Outreach is further affected by the importance of a target object. For example, if a malicious object modifies a security file that is important for the functionality of the computing device, the outreach is greater relative to if the target object is an unimportant object. Consider an example in which a malicious file reads/modifies/creates/deletes/encrypts ten other objects in a computing device. Severity calculator 110 may assign an importance level to each target object, where the importance level serves as a weight applied in a severity function. For example, there may be three tiers of importance: 1, 2, and 3. If there are three objects of the lowest rank (1), three objects of the middle rank (2), and four objects of the top rank (3), the severity calculation may be given by the amount of files affect plus the magnitude of effects (e.g., 10+3*1+3*2+4*3=31). In some aspects, each type of action (e.g., read, modify, etc.) may have its own weight as well. For example, reading may have a low weight, whereas encrypting may have a relatively higher weight. Suppose that the three lowest tier objects were encrypted (e.g., weight 4), the three mid-tier objects were deleted (e.g., weight 5), and suppose that the top tier objects were modified (e.g., weight 3). The severity calculation may be given by 10+3*1*4+3*2*5+4*3*3=10+12+30+36=88. In some aspects, the output of the calculation may be presented in a qualitative manner. For example, severity calculator 110 may refer to a plurality of thresholds that convert the quantitative value to a qualitative value. An example conversion is shown below:
0->30=Low
31->60=Medium
60->80=High
>80=Critical
   Accordingly, if the severity calculation is 88, the conversion would indicate a critical severity level. This value is output on the user interface (e.g., user interface 200).

Summary generator 114 is a module configured to generate an attack summary. An attack summary takes the information in an attack chain generated by attack chain generator 108 and presents it in layman terms. More technically, suppose that a source object (e.g., a browser application) downloads a malicious object (e.g., writes a target object to memory). The malicious object subsequently encrypts a security object of the user. While a user may navigate attack chain to receive this information, summary generator 114 uses summary templates 112 that match this chain and explains the situation. For example, summary templates 112 may catalogue dialogue representing different scenarios (e.g., file encryption, file download, etc.). Summary generator 114 matches the actions in attack chain to a plurality of summary templates and stitches them into an attack summary. For example, a summary template for downloading a malicious file may be “On [Insert Date], [Insert Browser Process Name] executed a plugin that wrote [Insert Malicious Object Name] to [Insert Target Directory Name].” A summary template for a malicious file encrypting a security file may be “On [Insert Date], [Insert Malicious Object Name] encrypted [Insert Target File Name].” When stitching these templates together, summary generator 114 may further use natural language processing to improve the transition from one template to another. For example, summary generator 114 may utilize a machine learning model specializing in natural language processing to generate the attack summary.

FIG. 2 is a diagram illustrating user interface 200 that visualizes an attack chain 202. Attack chain 202 is a visual tree that includes a plurality of branches. Each branch of attack chain 202 represents the result of an action. For example, as shown in FIG. 2, the workload device of attack chain 202 is “work_laptop,” which may be a computing device being monitored by EDR system 100. As shown in attack chain 202, “work_laptop” executes process “explorer.exe,” which causes user interface generator 106 to create the first branch. Subsequently, “explorer.exe” executes process “word.exe,” which leads to the creation of a second branch, and also reads “powershell.exe,” which leads to the creation of a third branch.

On a technical level, user interface generator 106 creates a visual identifier for each workload device, process, file, domain, registry, etc. In some aspects, a visual identifier is a button that includes an icon and name of an object (e.g., a workload device, process, file, etc.). For example, visual identifier 206 is a button that is shaped like a rectangular oval, has a gear icon, and the text “powershell.exe.” These visual identifiers are identified in legend 204 of the user interface. User interface generator 106 generates, in legend 204, a count for each type of visual identifier in attack chain 202. For example, in FIG. 2, there is 1 workload device (e.g., “work_laptop”), 10 processes (e.g., “explorer.exe,” “word.exe,” etc.), 51 files, etc.

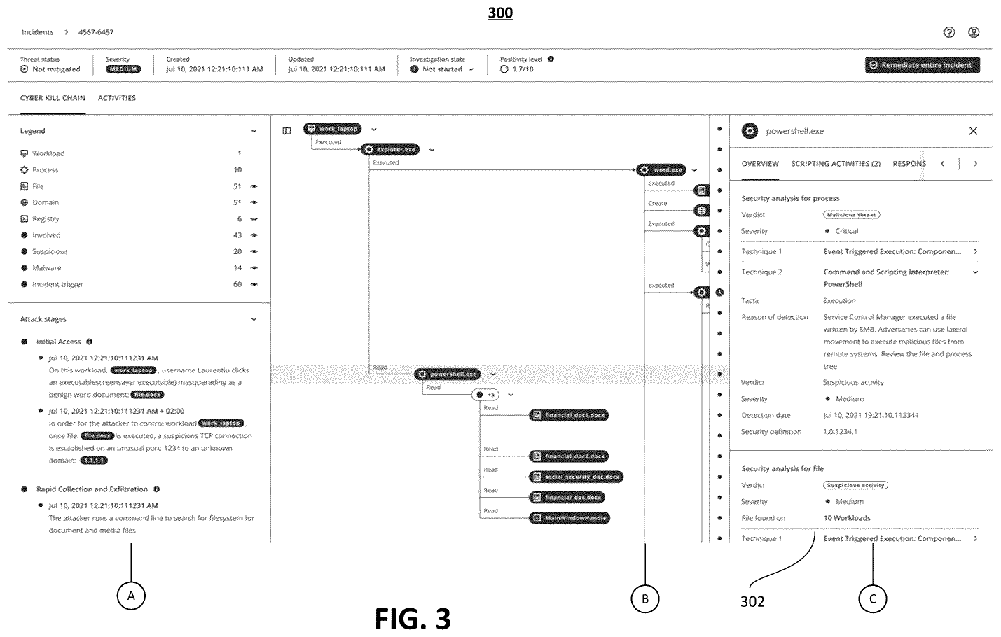

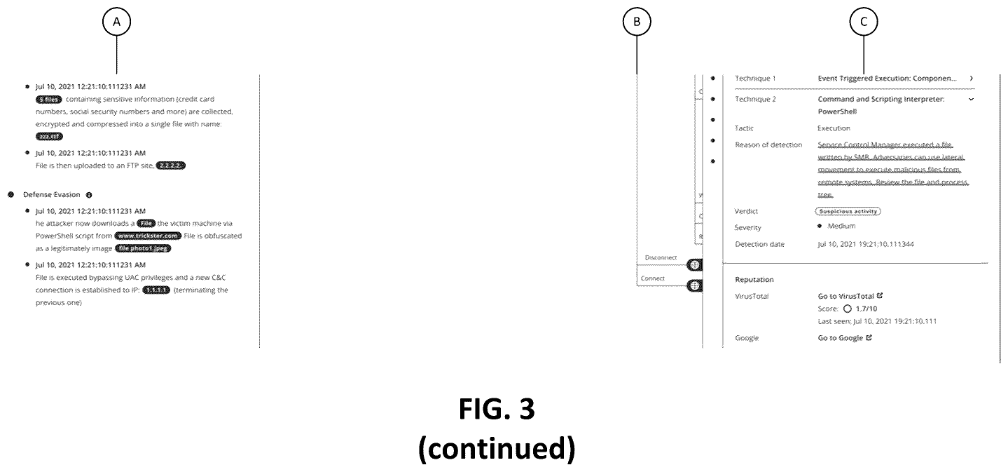

For each branch, user interface generator 106 displays, on user interface 200, the action that created the branch, the source object of the branch, and the target object of the branch. For example, the first branch has “work_laptop” as the source object, which performed an execution (marked “executed”). The target object of the branch is “explorer.exe.” In the second branch, the source object is “explorer.exe”, which performed an execution (marked “executed”). The target object of the branch is “word.exe.” In the third branch, the source object is “explorer.exe,” the action is a reading action, and the target object is “powershell.exe.” Each of the visual identifiers are selectable. For example, a user may select any visual identifier of “powershell.exe.” In response, user interface generator 106 may create a window (as shown in FIG. 3) that provides details about the selection (e.g., information about “powershell.exe”). As can be seen, a visual identifier of a specific object may appear multiple times in an action chain depending on how actively the object performs actions or is the target of an action.

User interface generator 106 further generates a timeline 208, which is scaled based on the branches in attack chain 202. Timeline 208 includes selectable time indicators, each of which correspond to a specific branch of attack chain 202. For example, a user may hover over a time indicator (as shown by the pointing cursor), which generates time window 210. Furthermore, user interface generator 106 may configure user interface 200 to highlight (e.g., partially shade) the branch associated with the selected time indicator. For example, the highlight in FIG. 2 shows that the selected time indicator is for when “financial_doc1.docx” was read by a source object associated with “powershell.exe.” Time window 210 indicates that the reading action was performed on Jul. 10, 2021 at 12:21:10:111234 AM.

User interface generator 106 further generates, below legend 204, an attack summary 212, which lists attack stages when an attack is detected. For example, in FIG. 2, attack summary 212 indicates that user “Laurentiu” selected “file.docx” on “work_laptop” on Jul. 10, 2021 at 12:21 AM. Attack summary 212 uses summary templates 112 to provide greater insight to the user, by describing in simple terminology, that the selected word document is associated with an executable screensaver masquerading as a benign word document. It should be noted that attack summary 212 further includes selectable visual identifiers similar to those shown in attack chain 202. Accordingly, a user may select a visual identifier to receive more information about the associated object. For example, the user may select the visual identifier labeled “file.docx” and user interface generator 106 may generate a window that describes “file.docx” in greater detail.

In some aspects, upon receiving a selection of the visual identifier, user interface generator 106 may modify a view of attack chain 202. For example, user interface generator 106 may (1) zoom into a portion of attack chain 202 that includes the selected object “file.docx” and/or (2) adjust the visual identifier of the selected object in attack chain 202 to make it more prominent (e.g., by changing the color, changing the visual style, adjusting a size, hiding unrelated branches, etc.).

User interface generator 106 may further generate summary bar 214, which lists information such as threat status, severity, creation time of attack chain 202, a last update time of attack chain 202, an investigation state, and a positivity level. A severity level may be a quantitative value describing how much the malicious activity may damage the workload, investigation state describes whether an administrator has reviewed and applied a remediation action, and positivity level is an internal metric based on a variety of factors.

User interface generator 106 may further generate a remediation action button 216, which generates a window listing actions that can resolve the detected malware issues upon selection.

As can be seen, user interface 200 provides a user with all the tools to efficiently determine what, how, and when an attack occurred. Conventional user interfaces may generate alerts that show the detected malicious activity (e.g., show that “powershell.exe” is a unreliable process). However, a user must then manually investigate where the process originates from, what damage the process has already done, and how to fix the issue. In contrast, user interface 200 of the present disclosure not only visualizes where “powershell.exe” originates from (e.g., read by “explorer.exe”), but what its file outreach has been, what the times of attack are, etc., using attack chain 202. The branch-style display eases navigation through a series of events that a conventional user interface that overwhelms users with substantial amounts of information or hides information in bland text blocks is unable to provide. With the help of legend 204 and timeline 208, a user can easily see the relationships between workloads, processes, files, etc. For users that are not as familiar with malware activity, attack summary 212 clearly lays out in layman terms what the attack involves. Lastly, summary bar 214 contextualizes the severity of the issue and gives the user immediate access to resolutions using the remediation action button 216.

In one aspect, user interface generator 106 generates attack chain 202 in real time. For example, attack chain 202 may first feature “work_laptop” executing “explorer.exe” at a first time. At a later time, user interface generator 106 may generate another branch that shows “explorer.exe” executing “word.exe.” At yet another later time, user interface generator 106 may generate yet another branch that shows “word.exe” executing “file.docx.” User interface generator 106 may shift the branches to different parts of the user interface for easier viewing by the user.

For example, as attack chain 202 is populated, it is possible that certain elements overlap in terms of time ranges. For example, element 220 (extending across both sheets) includes all objects associated with the execution by “explorer.exe.” Element 222 includes all objects associated with the execution of “word.exe,” and element 224 includes all objects associated with the execution of “powershell.exe.” Referring to element 222, “word.exe” executes “powershell.exe.” Suppose that this “powershell.exe” reads “financial_doc2.docx” at time t1. At time t2, “explorer.exe” reads “powershell.exe” as shown in element 224. “Powershell.exe” begins reading “financial_doc1.docx” and “financial_doc2.docx” during time range t3-t4. Within this time range, “powershell.exe” of element 222 reads “financial_doc.docx.” In response to determining that two actions from different elements are occurring during an overlapping time period, user interface generator 106 may shift the older element to a different part of the user interface. For example, the indicator of “word.exe” and its associated branches and indicators may be initially aligned along the column that “powershell.exe” of element 224 is. However, user interface generator 106 may detect that actions from element 224 and element 222 overlap in time after element 224 is generated, and may shift the indicator of “word.exe” and its associated branches and indicators to a right portion of the user interface to make the sequence of actions easier to view by the user.

FIG. 3 is a diagram illustrating a user interface 300 with a window 302 describing a malicious process selected in the attack chain. Suppose that a user navigating user interface 200 wants to learn more about a suspected process listed in attack chain 202. The user may select a visual identifier “powershell.exe,” and user interface generator 106 may generate window 302 in response.

Window 302 lists information about the selected identifier. In some aspects, window 302 includes a name of the object, a verdict of maliciousness, the severity of the malicious activity, and techniques used by the object to spread maliciousness. For example, for “powershell.exe,” window 302 indicates that there are two techniques of execution used. Window 302 further provides a reason for detection, stating “service control manager executed a file written by SMB. Adversaries can use lateral movement to execute malicious files from remote systems. Review the file and process tree.” Window 302 further lists a detection date of the malicious activity and the security definition used to detect the threat. In some aspects, window 302 includes the workloads that the object was detected on.

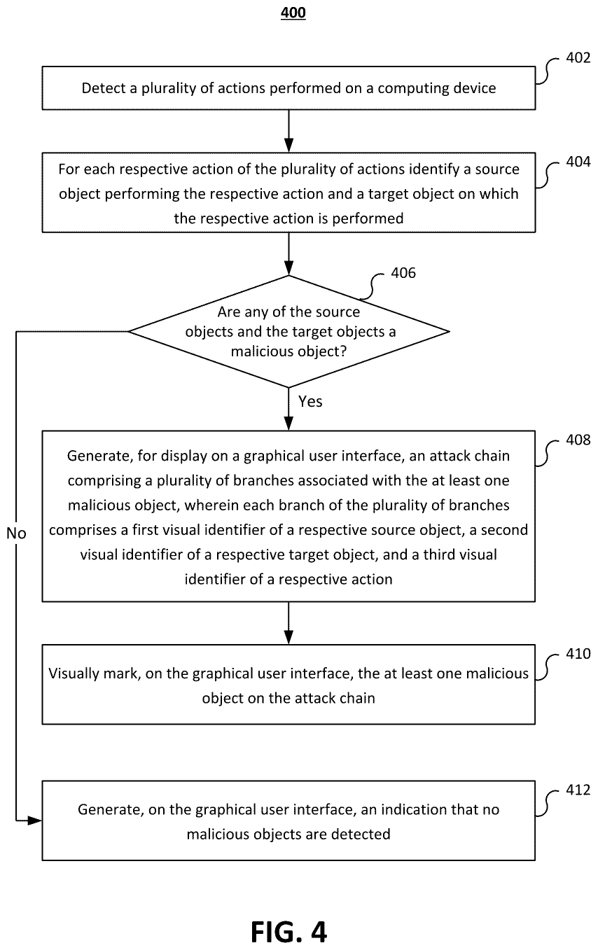

FIG. 4 illustrates a flow diagram of method 400 for generating an innovative user interface for an EDR system. At 402, user interface generator 106 detects a plurality of actions performed on a computing device (e.g., “work_laptop”). At 404, for each respective action of the plurality of actions, user interface generator 106 identifies a source object (e.g., “word.exe”) performing the respective action (e.g., “executed”) and a target object (e.g., “powershell.exe”) on which the respective action is performed. At 406, user interface generator 106 determines (e.g., using malware detector 102) whether any of the source object and the target object is a malicious object.

In response to detecting at least one malicious object, method advances from 406 to 408, where user interface generator 106 generates, for display on a graphical user interface (e.g., user interface 200), an attack chain (e.g., attack chain 202) comprising a plurality of branches associated with the at least one malicious object, wherein each branch of the plurality of branches comprises a first visual identifier of a respective source object, a second visual identifier of a respective target object, and a third visual identifier of a respective action.

At 410, user interface generator 106 visually marks, on the graphical user interface, the at least one malicious object on the attack chain. For example, user interface generator 106 may use an icon (as shown in legend 204) that indicates whether an object is malware.

In response to detecting no malicious objects at 406, method 400 advances to 412, where user interface generator 106 generates, on the graphical user interface, an indication that no malicious objects are detected. For example, in the zone depicting attack chain 202, user interface generator 106 may generate a message stating “No malicious activity detected.”

In some aspects, user interface generator 106 subsequently receives a selection of a visual identifier associated with the at least one malicious object. In response to receiving the selection, user interface generator 106 generates, for display on the graphical user interface, a window (e.g., window 302) that includes additional information about the at least one malicious object. The additional information may include a verdict on maliciousness, a reason of detection, a tactic used for malicious activity, a detection date, a security definition used to detect the at least one malicious object.

Furthermore, in response to receiving the selection, user interface generator 106 modifies visual identifiers not directly associated as source objects or target objects with the at least one malicious object such that the attack chain solely depicts visual identifiers of the at least one malicious object.

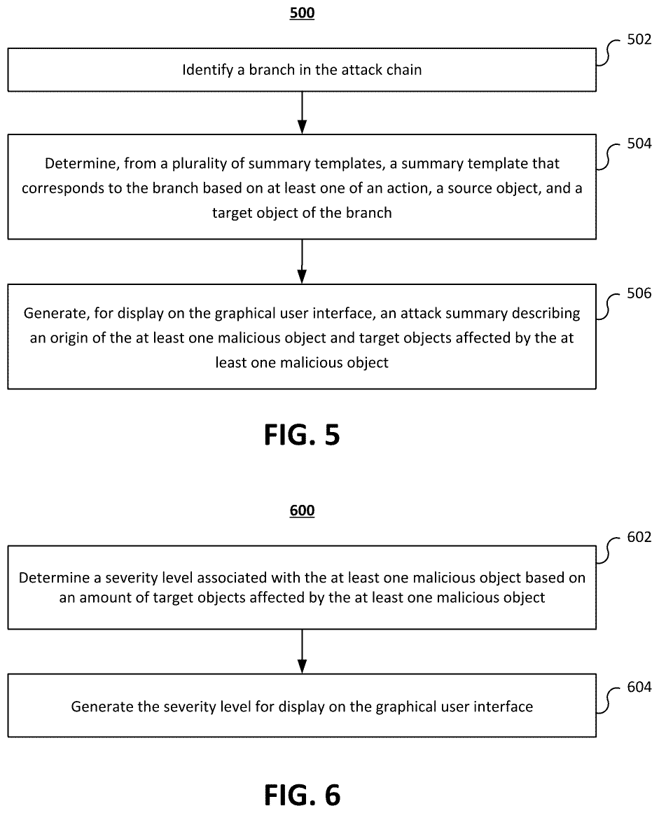

FIG. 5 illustrates a flow diagram of method 500 for generating an attack summary (e.g., attack summary 212) associated with the attack chain. At 502, user interface generator 106 identifies a branch in the attack chain. At 504, user interface generator 106 determines, from a plurality of summary templates, a summary template that corresponds to the branch based on at least one of an action, a source object, and a target object of the branch. The summary template includes text describing an attack event and fields for entering identifiers of the action, the source object, and the target object of the branch.

At 506, user interface generator 106 generates, for display on the graphical user interface, an attack summary describing an origin of the at least one malicious object and target objects affected by the at least one malicious object. In some aspects, the attack summary comprises visual identifiers of the at least one malicious object and the target objects affected by the at least one malicious object.

FIG. 6 illustrates a flow diagram of method 600 for generating a severity level. At 602, user interface generator 106 determines a severity level associated with the at least one malicious object based on an amount of target objects affected by the at least one malicious object. The severity level is a function of an importance of each target object and a type of action applied on each target object by the at least one malicious object.

At 604, user interface generator 106 generates the severity level for display on the graphical user interface (e.g., in summary bar 214).

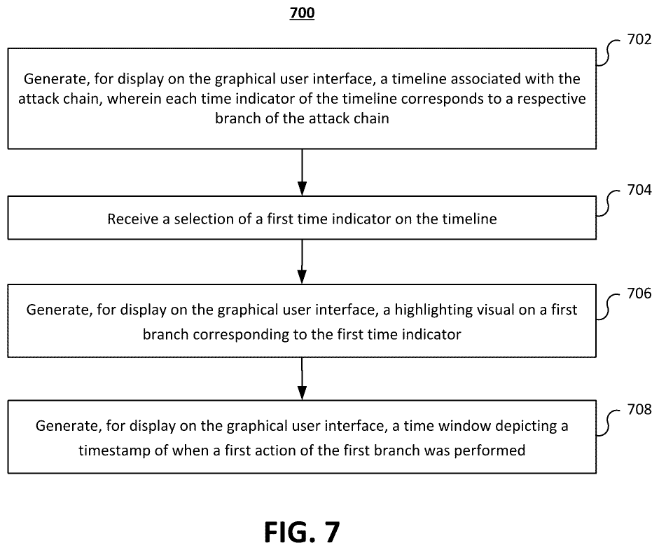

FIG. 7 illustrates a flow diagram of method 700 for generating a timeline (e.g., timeline 208) of the attack chain. At 702, user interface generator 106 generates, for display on the graphical user interface, a timeline associated with the attack chain, wherein each time indicator of the timeline corresponds to a respective branch of the attack chain.

At 704, user interface generator 106 receives a selection of a first time indicator on the timeline. At 706, user interface generator 106 generates, for display on the graphical user interface, a highlighting visual on a first branch corresponding to the first time indicator. At 708, user interface generator 106 generates, for display on the graphical user interface, a time window (e.g., time window 210) depicting a timestamp of when a first action of the first branch was performed.

FIG. 8 is a block diagram illustrating a computer system 20 on which aspects of systems and methods for generating an innovative user interface for EDR systems may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for generating an innovative user interface for endpoint detection and response (EDR) systems, the method comprising:
detecting a plurality of actions performed on a computing device;
for each respective action of the plurality of actions:
identifying a source object performing the respective action and a target object on which the respective action is performed;
determining whether any of the source object and the target object is a malicious object;
in response to detecting at least one malicious object, generating, for display on a graphical user interface, an attack chain comprising a plurality of branches associated with the at least one malicious object, wherein each branch of the plurality of branches comprises a first visual identifier of a respective source object, a second visual identifier of a respective target object, and a third visual identifier of a respective action; and
visually marking, on the graphical user interface, the at least one malicious object on the attack chain.

2. The method of claim 1, further comprising:
generating, for display on the graphical user interface, an attack summary describing an origin of the at least one malicious object and target objects affected by the at least one malicious object.

3. The method of claim 2, wherein generating the attack summary comprises:
identifying a branch in the attack chain;
determining, from a plurality of summary templates, a summary template that corresponds to the branch based on at least one of an action, a source object, and a target object of the branch, wherein the summary template comprises text describing an attack event and fields for entering identifiers of the action, the source object, and the target object of the branch.

4. The method of claim 2, wherein the attack summary comprises visual identifiers of the at least one malicious object and the target objects affected by the at least one malicious object.

5. The method of claim 1, further comprising:
determining a severity level associated with the at least one malicious object based on an amount of target objects affected by the at least one malicious object; and
generating the severity level for display on the graphical user interface.

6. The method of claim 5, wherein the severity level is a function of an importance of each target object and a type of action applied on each target object by the at least one malicious object.

7. The method of claim 1, further comprising:
receiving a selection of a visual identifier associated with the at least one malicious object;
in response to receiving the selection, generating, for display on the graphical user interface, a window that includes additional information about the at least one malicious object.

8. The method of claim 7, wherein the additional information includes a verdict on maliciousness, a reason of detection, a tactic used for malicious activity, a detection date, a security definition used to detect the at least one malicious object.

9. The method of claim 7, further comprising:
in response to receiving the selection, modifying visual identifiers not directly associated as source objects or target objects with the at least one malicious object such that the attack chain solely depicts visual identifiers of the at least one malicious object.

10. The method of claim 1, further comprising:
generating, for display on the graphical user interface, a timeline associated with the attack chain, wherein each time indicator of the timeline corresponds to a respective branch of the attack chain.

11. The method of claim 10, further comprising:
receiving a selection of a first time indicator on the timeline;
generating, for display on the graphical user interface, a highlighting visual on a first branch corresponding to the first time indicator; and
generating, for display on the graphical user interface, a time window depicting a timestamp of when a first action of the first branch was performed.

12. A system for generating an innovative user interface for endpoint detection and response (EDR) systems, comprising:
at least one memory; and
at least one hardware processor coupled with the at least one memory and configured, individually or in combination, to:
detect a plurality of actions performed on a computing device;
for each respective action of the plurality of actions:
identify a source object performing the respective action and a target object on which the respective action is performed;
determine whether any of the source object and the target object is a malicious object;
in response to detecting at least one malicious object, generate, for display on a graphical user interface, an attack chain comprising a plurality of branches associated with the at least one malicious object, wherein each branch of the plurality of branches comprises a first visual identifier of a respective source object, a second visual identifier of a respective target object, and a third visual identifier of a respective action; and
visually mark, on the graphical user interface, the at least one malicious object on the attack chain.

13. The system of claim 12, wherein the at least one hardware processor is further configured to:
generate, for display on the graphical user interface, an attack summary describing an origin of the at least one malicious object and target objects affected by the at least one malicious object.

14. The system of claim 13, wherein the at least one hardware processor is further configured to generate the attack summary by:
identifying a branch in the attack chain;
determining, from a plurality of summary templates, a summary template that corresponds to the branch based on at least one of an action, a source object, and a target object of the branch, wherein the summary template comprises text describing an attack event and fields for entering identifiers of the action, the source object, and the target object of the branch.

15. The system of claim 13, wherein the attack summary comprises visual identifiers of the at least one malicious object and the target objects affected by the at least one malicious object.

16. The system of claim 12, wherein the at least one hardware processor is further configured to:
determine a severity level associated with the at least one malicious object based on an amount of target objects affected by the at least one malicious object; and
generate the severity level for display on the graphical user interface.

17. The system of claim 16, wherein the severity level is a function of an importance of each target object and a type of action applied on each target object by the at least one malicious object.

18. The system of claim 12, wherein the at least one hardware processor is further configured to:
receive a selection of a visual identifier associated with the at least one malicious object;
in response to receiving the selection, generate, for display on the graphical user interface, a window that includes additional information about the at least one malicious object.

19. The system of claim 18, wherein the additional information includes a verdict on maliciousness, a reason of detection, a tactic used for malicious activity, a detection date, a security definition used to detect the at least one malicious object.

20. A non-transitory computer readable medium storing thereon computer executable instructions for generating an innovative user interface for endpoint detection and response (EDR) systems, including instructions for:
detecting a plurality of actions performed on a computing device;
for each respective action of the plurality of actions:
identifying a source object performing the respective action and a target object on which the respective action is performed;
determining whether any of the source object and the target object is a malicious object;
in response to detecting at least one malicious object, generating, for display on a graphical user interface, an attack chain comprising a plurality of branches associated with the at least one malicious object, wherein each branch of the plurality of branches comprises a first visual identifier of a respective source object, a second visual identifier of a respective target object, and a third visual identifier of a respective action; and
visually marking, on the graphical user interface, the at least one malicious object on the attack chain.
